(19) United States
(12) Patent Application Publication
(10) Pub. No.: US 2004/0174335 A1
(43) Pub. Date: Sep. 9, 2004

(54) Driver control scheme for electronic-ink display

(76) Inventors: Lee Wang, Taipei (TW); Jin-Yi Chang, Taipei (TW)

Correspondence Address: BRUCE H. TROXELL, SUITE 1404, 5205 LEESBURG PIKE, FALLS CHURCH, VA, 22041, US

(21) Appl. No.: 10/376,306

(22) Filed: Mar. 3, 2003

(51) Int. Cl. G09G 3/38; G09G 3/34

(52) U.S. Cl. 345/105; 345/84

(57) ABSTRACT

Electronic Ink is new display device offering excellent resolution and high contrast under a wide range of viewing angles, requiring no external power to retain its image. However, designing electronic ink display device always posts a challenge to achieve high resolutions, flexible functionality, and low cost manufacturability. Since the number of controls to each individual pixel on a display increases with resolutions and display's functions, the display design becomes more complicated and drives to higher manufacture cost. Here, we propose to apply the threshold property of the electronic ink in response to applied electrical fields to design simplified displays with good resolutions, flexible functionality, and low cost manufacturability.

### BACKGROUND OF THE INVENTION

(1) Field of the Invention

The invention relates to an electronic ink display, and more particularly to the display scheme of electronic ink material.

(2) Description of the Prior Art

Electronic ink is a new display device offering excellent resolution and high contrast under a wide range of viewing angles, requiring no external power to retain its image. The first electronic ink was demonstrated in 1975 at Xerox Palo Alto Research Center. As shown in FIG. 1, the black-and-white electronic ink material rotatable elements 12 are embedded in a sheet of optically transparent material 16, that contains a multiplicity of cavities 14. Each of the cavities 14 is permeated by a transparent dielectric fluid, such as a viscous oil. The fluid-filled cavities 14 accommodate the electronic ink material rotatable elements 12, one electronic ink material rotatable element 12 per cavity 14, to prevent the rotatable elements 14 from migrating within the sheet. Each cavity 14 is slightly larger than the size of the electronic ink material rotatable element 12 so that each electronic ink material rotatable element 12 can rotate or move slightly within its cavity 14.

An electronic ink material rotatable element 12 can be selectively rotated within its respective fluid-filled cavity 14 by applying an electric field from the electrodes 10, so that either a specific portion of the electronic ink material rotatable element 12 is exposed to an observer viewing the surface of the sheet. By applying an electric field in two dimensions, for example, using a matrix addressing scheme, the black and white sides of the rotatable elements 12 for instance can be caused to appear as the image elements, e.g., pixels or subpixels, of a displayed image.

One drawback of such displays is that they are difficult to practically and economically address. One common means of addressing is known as direct drive addressing, in which each pixel is controlled by its own external drive circuit. This scheme is both expensive and impractical for displays containing a large number of pixels and for displays containing pixels that are tightly packed.

However, designing electronic ink display device always posts a challenge to achieve high resolutions, flexible functionality, and low cost manufacturability. Since the number of controls to each individual pixel on a display increases with resolutions and display's functions, the display design becomes more complicated and drives to higher manufacture cost. Here, we propose to apply the threshold property of the electronic ink in response to applied electrical fields to design simplified displays with good resolutions, flexible functionality, and low cost manufacturability. Although the working principle of the proposed electronic ink displays is quite different from those of conventional Liquid Crystal Display (LCD), similar to the Twisted Nematic (TN) and Super Twisted Nematic (STN) type of LCD, the proposed electronic ink display does not require in-pixel switching devices as the Thin-Film-Transistor Liquid Crystal Display (TFT-LCD). The proposed scheme simplifies the display design such that the electronic ink display can be manufactured with lower cost.

### SUMMARY OF THE INVENTION

Accordingly, it is a primary object of the present invention to provide a simplified electronic ink display using the electrical properties of electronic ink. The display does not need in-pixel switching device to achieve high resolution and flexible functionality. The present invention can provide a feasible and cost effective solution for electronic ink display due to its simplicity.

The electronic ink display includes an electronic ink material, a plurality of pixels of array and a multiple voltage output device. The electronic ink material is sandwiched by the plurality of pixels of array and able to change their bright-dark contrast by responding to the applied electrical fields, which is generated by the plurality of pixels of array. The plurality of pixels of array are formed by two groups of electrodes, which are overlapped with each other. And the multiple voltage output device further includes, a connector, a controller, a data latch device, and a DC/DC converter. And all those devices are mounted on a printed circuit board (PCB).

As the foregoing says, one group of electrodes is applied to a signal voltage after the other group of electrodes is pre-charged to a certain voltage. More specifically, one group of electrodes are selected lines of electrodes and deselected the remaining electrodes, while the pixel signals are sent to the other group of electrodes and enables a line-scanning scheme. Then, one group of electrodes are selected and deselected which are achieved by applying distinct voltages such that the electrical fields between the selected electrodes and signaled electrodes enable the electronic ink material contrast state on-off, while the electrical fields between deselected electrodes and the signaled electrodes are not able to turn on said electronic ink material contrast state.

The foregoing, as well as additional objects, features and advantages of the invention will be more readily apparent from the following detailed description which proceeds with reference to the accompanying drawings.

### BRIEF DESCRIPTION OF THE DRAWINGS

The present invention will now be specified with reference to its preferred embodiment illustrated in the drawings, in which

FIG. 1 is a schematic representation of electronic ink material and driving same;

FIG. 2 is a schematic cross-sectional view of the display panel in accordance with the present invention;

FIG. 3 is a schematic view of the driving system with two groups of electrodes in accordance with the present invention; and

FIG. 4 is a schematic view of display system in accordance with the present invention.

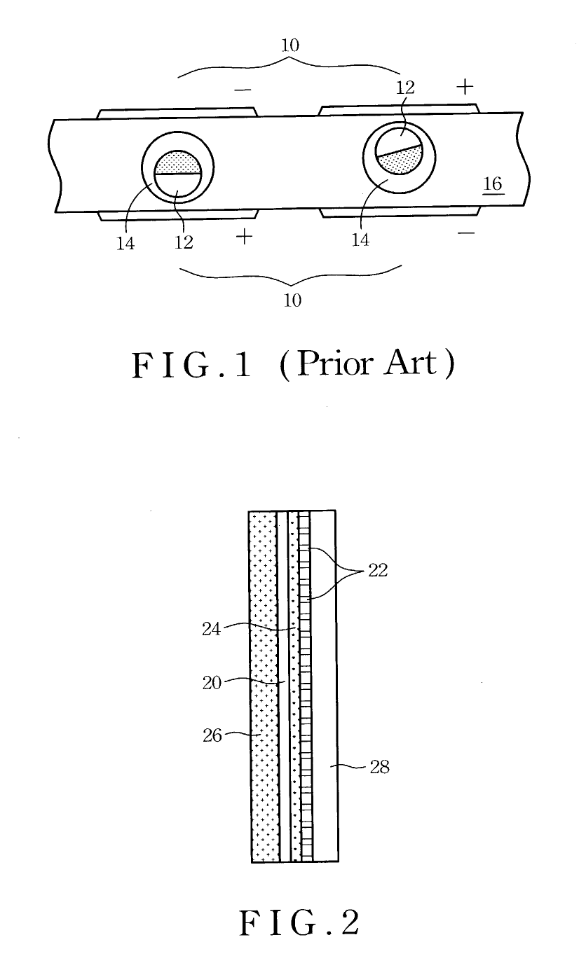

### DESCRIPTION OF THE PREFERRED EMBODIMENT

The invention disclosed herein comprises a hardware design of electronic ink display and a method of using a multiple voltage driver to drive dot-matrix type of display without using in-pixel switch device or complicated multiple-layer hardware design. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Referring to FIG. 2, the display design herein only requires two groups of electrodes 20 and 22 lying on two sides, where the electronic ink material 24 is sandwiched between them. Besides, the display is formed on a substrate 26 and covered with a cover 28. Due to the contrast spheres embedded inside viscous oil within the cavities, the polarized spheres show characteristics of rotation threshold with the applied electrical fields. That is, the spheres begin to rotate to align with the applied fields above some critical electrical field strength, while remain still below the critical electrical field.

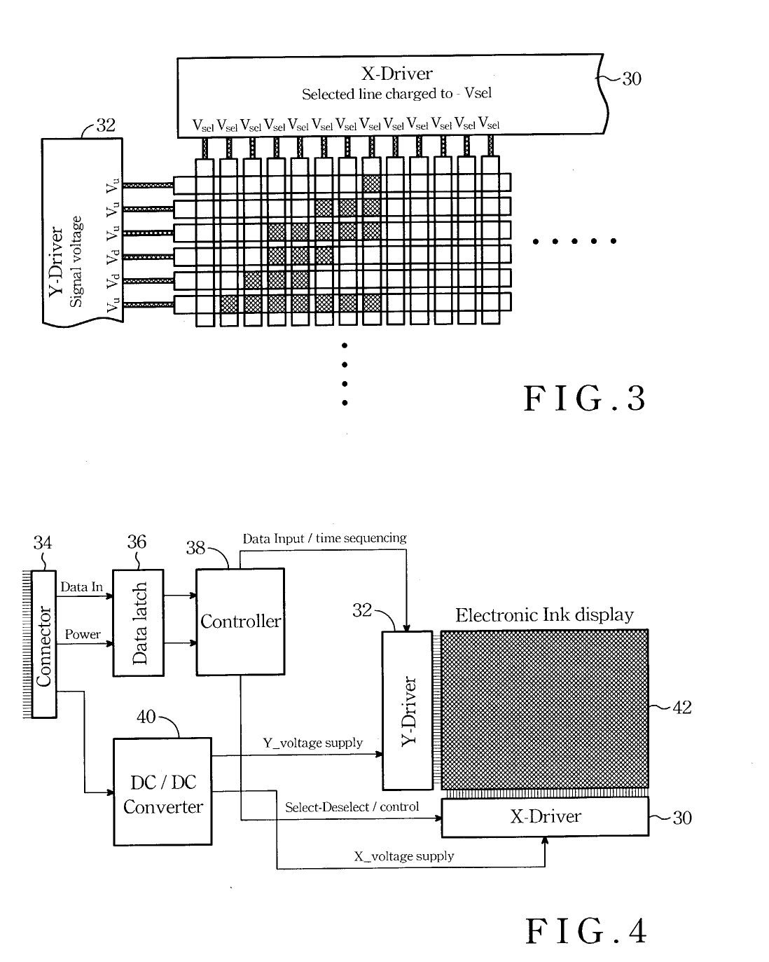

Two multiple voltage drivers, X-Driver 30 and Y-Driver 32, drive two groups of electrodes, X-electrodes and Y-electrodes, as shown in FIG. 3. To illustrate the basic idea, we use the selected line in X-electrodes is pre-charged to some negative voltage, −Vsel. Then, the signal voltages, either Vᵤ or V_{d}, are simultaneously sent into Y-electrodes. The voltage differences along the selected line are the signal voltages subtracting the selected line voltage, that is, either Vᵤ+Vsel or V_{d}+Vsel. The corresponding electrical fields with voltage difference, Vᵤ+Vsel, inside the pixels (overlapped areas with Vᵤ signal electrodes along the selected electrode) are above critical fields and strong enough to flip the contrast state reversed, while the corresponding electrical fields with voltage difference, V_{d}+Vsel, inside the pixels (overlapped areas with V_{d} signal electrodes along the selected electrode) are still below the critical field and the contrast states remain no change. Here, we denote the critical voltage difference, Vth, for the critical field. The deselected voltage, Vdes, is applied to all the deselected electrodes during the operation such that the voltage differences between the signaled electrodes and the deselected electrodes are either Vᵤ−Vdes or V_{d}−Vdes. The corresponding fields with voltage differences inside the pixels (overlapped areas between the signal electrodes and the deselected electrodes) are required to be less than the critical field such that the signal electrodes do not disturb the pixels on the unselected electrodes. To summarize, we would have the necessary conditions:

1. Vᵤ+Vsel>Vth

2. V_{d}+Vsel<Vth

3. −Vth<Vᵤ−Vdes<Vth

4. −Vth<V_{d}−Vdes<Vth Those conditions are the criteria to drive the electrical ink display without using in-pixel switching device for controlling independent pixels.

The block diagram in FIG. 4 exemplifies the completed display module. The connector 34 connects to the equipment system. The X-Driver 30 and Y-Driver 32 can either be used for signal in or select-deselect line function in the electronic ink display 42. The DC/DC converter 40 supplies the required DC voltages for the signal voltages Vᵤ and V_{d}, and line voltages, Vsel and Vdes. The controller 38 controls the signal inputs and select-deselect function to the X-Driver 30 and Y-Driver 32. The data latch device 36 sequences the data from the connector 34 and hold the data to the controller 38.

This invention applies electronic ink electrical properties to design electronic ink display with high resolutions, flexible functionality, and low cost to manufacture. The innovative control scheme to pixels of array reduces the display design complexity such that the electronic ink displays become feasible and cost effective devices.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as will as other embodiments, are intended to be included within the scope of the appended claims. The invention is defined by the following claims, with equivalents of the claims to be included therein.

I claim:

1. An electronic ink display, comprising:
an electronic ink material with bright-dark contrast and threshold properties;
a plurality of pixels of array containing said electronic ink material; and
a multiple voltage output device to drive said plurality of pixels of array.

2. The display of claim 1, wherein said electronic ink material is able to change their bright-dark contrast by responding to the applied electrical fields.

3. The display of claim 1, wherein said electronic ink material has threshold type of response to the applied electrical fields.

4. The display of claim 1, wherein said plurality of pixels of array are formed by two groups of electrodes.

5. The display of claim 4, wherein said two groups of electrodes, one group of electrodes is a X-electrodes, and the other group of electrodes is a Y-electrodes.

6. The display of claim 4, wherein said two groups of electrodes overlap with each other.

7. The display of claim 1, wherein said electronic ink material is sandwiched by said two groups of electrodes.

8. The display of claim 1, wherein said multiple voltage output device further comprising:
a connector connects to the equipment system;
a controller receiving display signals from said connector to control the output voltages and timing sequence;
a data latch device sequences the data from said connector and hold the data to said controller; and
a DC/DC converter to manage distinct voltages required in the outputs of said two groups of electrodes.

9. The display of claim 6, wherein said multiple voltage output device is mounted on printed circuit board (PCB).

10. The display of claim 6, wherein said X-electrodes is applied to signal voltages after said Y-electrodes is pre-charged to certain voltages.

11. The display of claim 6, wherein said two groups of electrodes are applied with distinct voltages that electrical fields exist there between.

12. The display of claim 11, wherein said electrical fields enable to turn on-off the contrast state of said electronic ink material.

13. The display of claim 6, wherein said X-electrodes are selected lines of electrodes and deselected the remaining electrodes, while the pixel signals are sent to said Y-electrodes enables a line-scanning scheme.

14. The display of claim 13, wherein said X-electrodes are selected and deselected which are achieved by applying distinct voltages such that the electrical fields between the selected electrodes and signaled electrodes enable said electronic ink material contrast state on-off, while the electrical fields between deselected electrodes and the signaled electrodes are not able to turn on said electronic ink material contrast state.
